(19) United States
(12) Patent Application Publication
(10) Pub. No.: US 2006/0173671 A1
(43) Pub. Date: Aug. 3, 2006

(54) Localizing tool for client software

(75) Inventor: Takuya Okawa, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/050,065

(22) Filed: Feb. 2, 2005

(51) Int. Cl. G06F 17/28

(52) U.S. Cl. 704/5

(57) ABSTRACT

A localizing tool which converts the language of a first document data file which stores character information of character strings to be displayed in an original language in a printer driver to another language comprises an information storage section, a printer driver storing section which stores the printer driver in the information storage section, and a conversion section which converts the first document data file in the printer driver stored in the information storage section into a second document data file in an object language different from the original language.

### BACKGROUND OF THE INVENTION

The present invention relates to a localizing tool which adapts client software, such as a printer driver, to a country or area where the client software is used.

Client software which runs on personal computers holds a GUI (Graphical User Interface) which allows menus and so on to appear on the screen. In order to adapt the client software to a country or area where the software is used, it is required to convert all the words (hereinafter referred to as the character strings), such as messages on setting menus displayed on the screen by the GUI to the language of that country or area. The character strings include sentences, explanatory notes, messages, and words.

Usually, character strings used in menus and messages displayed by the GUI are held as resources in a program. The character strings are generally preserved as compiled data together with the program. When language conversion is made, therefore, the program is recompiled for each language.

For this reason, to make language conversion, joint work by a technical expert who has a detailed knowledge of the program and a translator is required. It is therefore difficult for a user or translator to make language conversion in a country or area where the program is used.

### BRIEF SUMMARY OF THE INVENTION

In order to achieve the above object, according to one aspect the present invention, there is provided a localizing tool which converts the language of a first document data file which stores character information of character strings to be displayed in an original language in a printer driver to another language comprising: an information storage section; a printer driver storing section which stores the printer driver in the information storage section; and a conversion section which converts the first document data file in the printer driver stored in the information storage section into a second document data file in an object language different from the original language.

### BRIEF DESCRIPTION OF THE SEVERAL VIEWS OF THE DRAWING

FIG. 1 is a block diagram illustrating the configuration of a printer driver language conversion system according to an embodiment of the present invention;

FIG. 2 is a block diagram illustrating the configuration of a device to which the system of FIG. 1 is applied;

FIG. 3 is a flowchart illustrating a language conversion processing operation according to an embodiment of the present invention;

FIG. 4 is a diagram illustrating the situation of language conversion processing;

FIG. 5 is a flowchart illustrating an operation of creating a new object language document data file; and

FIG. 6 is a diagram illustrating a translation screen displayed on translation of character strings.

### DETAILED DESCRIPTION OF THE INVENTION

An embodiment of the present invention will be described hereinafter with reference to the accompanying drawings.

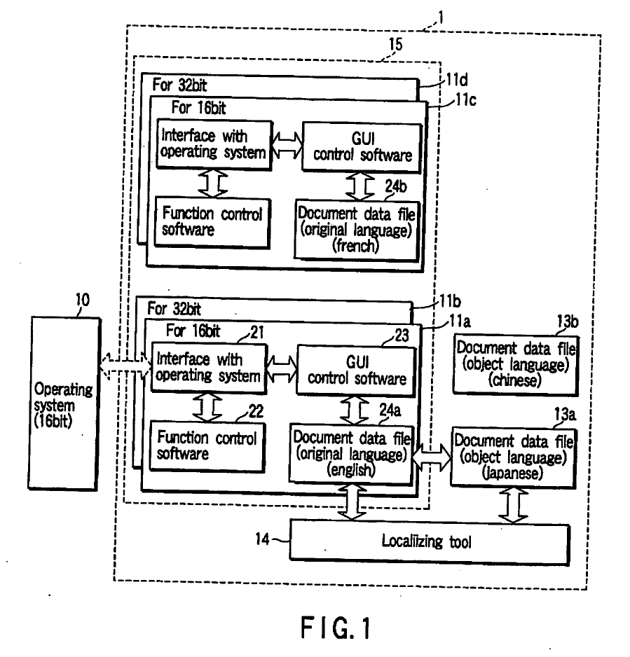

FIG. 1 is a block diagram illustrating a relationship among components constituting a printer driver language conversion system 1 according to an embodiment of the present invention.

This embodiment will be described in terms of a printer driver as client software. The printer driver is client software which enables a terminal, such as a PC, to make printing using a printer connected to it. From the following description it will become evident that the present invention can be applied not only to a printer driver but also to any other client software.

The language translation system 1 includes document data files 13a and 13b created by different languages, a localizing tool 14 which executes language conversion according to one embodiment of the present invention, and a printer driver set 15. Reference numeral 10 denotes an operating system, such as Windows or Macintosh.

In the description which follows, “language” indicates a language of character strings including sentences, explanatory notes, words, etc., in the menus displayed on the display screen when the printer driver runs. The printer driver set 15 includes printer drivers 11a and 11b each having a document data file 24a in English by way of example and printer drivers 11c and 11d each having a document data file 24b in French by way of example. Each printer driver contains an interface 21 with the operating system, function control software 22, GUI control software 23, and an original document data file 24.

Here, the printer driver 11 is made available in two types for 16 and 32 bits so that they can be is adapted for operating systems of different forms. The printer drivers 11a and 11c are adapted for a 16-bit operating system, while the printer drivers 11b and 11d are adapted for a 32-bit operating system. The document data file is a file that stores all character strings which are displayed on various operating screens, such as menus, which are displayed on the display device as GUI when the user actually uses the printer driver.

The original document data files 24 are document data files which have been incorporated into the printer drivers from the beginning. In this embodiment, the original data files are available as document data files in English and French. As document data files in object languages, a document data file 13a in Japanese and a document data file 13b in Chinese are prepared.

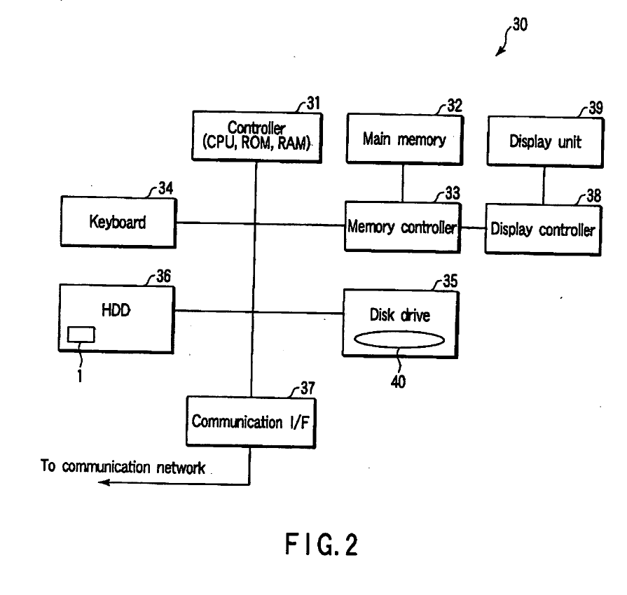

FIG. 2 is a block diagram illustrating the configuration of a device 30 to which the system of FIG. 1 is applied. The device 30 can be composed of, say, a PC. The device 30 is hereinafter referred to as the PC 30. The PC 30 includes a controller 31, a memory 32, a memory controller 33, a keyboard 34, a disk drive 35, a hard disk driver (HDD) 36, a communication interface (I/F) 37, a display controller 38, and a display unit 39.

The controller 31 includes a CPU, a ROM stored with a control program, and a RAM used as a working area and exercises overall control on the PC 30 on the basis of user commands entered from the keyboard 34. The disk drive 35 records or reproduces information on or from an optical disk 40, such as a CD or DVD.

The memory controller 33, under the control of the controller 31, records information, such as image data, character data, etc., which is delivered from the HDD 36, the disk driver 35 or the communication interface 37, on the main memory 32 or sends it to the display controller 38. In addition, the memory controller 33, under the control of the controller 31, provides information recorded on the main memory 32 to the HDD 38, the disk drive 35, the communication interface 37, or the display controller 38. The display controller 38 converts image data from the memory controller 33 into data suitable for display on the display unit 39 and displays it on the display unit 39.

Returning to the description of FIG. 1, the printer drivers 11 are provided to a user in the form stored on a CD by way of example and copied from the CD into the HDD 36 for use. Alternatively, the printer drivers 11 are downloaded from a server connected through a communication network, such as the Internet, into the HDD 36 in the PC 30 for use. Furthermore, in order to increase the processing speed, the printer drivers 11 are copied into the semiconductor memory 32, such as a RAM, and used at print time.

In making the language conversion of the present invention, the localizing tool 14, the printer driver set 15 and the object language document data files 13a and 13b are stored into the HDD 16. The CD for printer drivers according to the present invention contains the printer driver set 15, i.e., a plurality of printer drivers 11a to 11d which can be adapted to operating systems of different forms and languages. That is, a CD containing the printer driver set 15 is provided to users as the printer driver CD. The printer driver set 15 may be downloaded from a server on a communication network into the HDD over that communication network.

Next, an embodiment of the localizing tool 11 of the present invention will be described in detail.

In the present invention, information of all character strings the printer drivers display is filed and managed collectively as one document data file so that it can easily be separated from the printer driver software. One document data file 24 recorded with original character strings is read from the printer driver set 15 and the character strings are converted from an original language into an object language. At this time, no change takes place in the organization of the document data file and the storage address of each character string. The object language is the one of an area where the printer or MFP (multi-function peripheral) having the printer is sold or used.

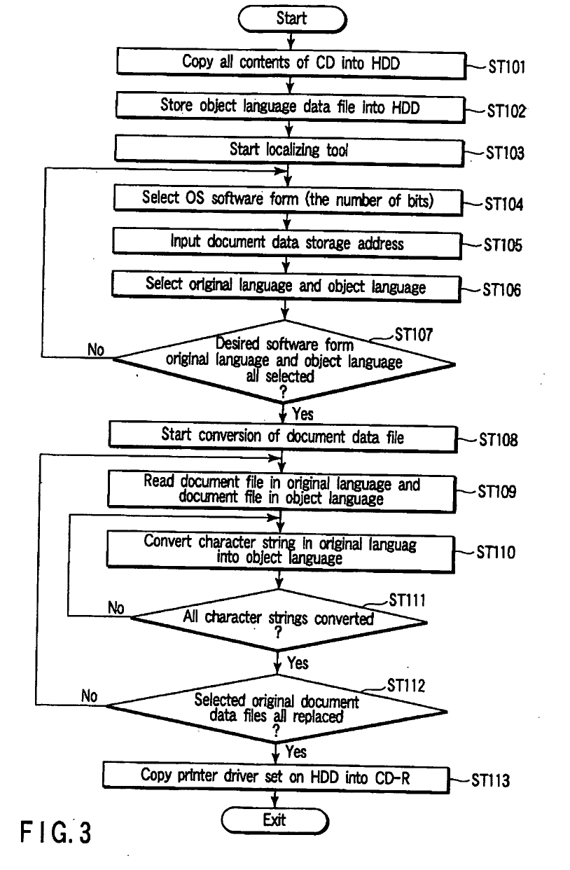

FIG. 3 is a flowchart illustrating one embodiment of the inventive language conversion processing. The present embodiment will be described by way of an example of making language conversion through the use of a printer driver CD containing the printer driver set 15. Suppose that the localizing tool 14 has been previously stored into the HDD 36.

First, the controller 31, when commanded by the user, copies all the contents including the printer driver set 15 stored on the printer driver CD into the HDD 36 (ST 101). In step ST 102, the object language data files 13a and 13b are stored into the HDD 36. As the result, software and data associated with the printer driver language conversion system 1 are stored into the HDD 36 as shown in FIG. 2. As will be described later, the object language data files 13a and 13b are document data files which are created by previously translating character strings contained in an original document data file 24 incorporated into the printer driver 11 into object languages. In step ST 103, the localizing tool 14 is started in response to a user command. At this time, the localizing tool 14 is copied from the HDD 36 into the main memory 32 and then put into execution.

The language conversion processing is executed by the controller 31 reading in and interpreting the localizing tool 14. However, the localizing tool 14 may be implemented in hardware that performs the printer driver language conversion processing independently. The following steps are described as steps the localizing tool 14 carries out.

The localizing tool 14 displays a screen to select a printer driver operating environment, i.e., an OS software form, on the display unit 39 and selects an OS software form in response to a corresponding input from the user (ST 104). The OS software is available in various forms. For example, data transfer forms are a 16-bit form and a 32-bit form. Here, the number of bits, such as 16 bits or 32 bits, is selected as the OS software form.

The localizing tool 14 displays a document data file storage address select screen on the display unit 39 and determines a document data file storage address in response to a corresponding input from the user (ST 105). The document data file storage address indicates the address in which a document data file 24 is stored and varies for each OS. The localizing tool 14 inputs the address indicating the stored location of the document data file in the printer driver which operates under the OS environment selected in step ST 104 from the user and stores it.

The localizing tool 14 selects an original language and an object language on the basis of user inputs (ST 106). In this embodiment, as described above, the original language is available in English and French. The object languages is available in Japanese and Chinese.

In step ST 107, the localizing tool 14 inquires of the user whether the desired OS-software form, the original language and the object language have all been selected. In the presence of another OS software form, original language or object language to be selected, steps ST 104 to ST 106 are carried out again to select another software form, document data file storage address, original language and object language.

When all the software forms the user desires and the corresponding document data file storage addresses, original languages and object languages are selected (YES in ST 107), the localizing tool 14 starts conversion of the document data files (ST 108).

The localizing tool 14 reads from the HDD 36 the document data file in the selected form and the selected original language and the document file 13 in the object language and stores them into the memory 36 (ST 109). The localizing tool 14 converts character strings in the original language into character strings in the object language in steps ST 110 and ST 111.

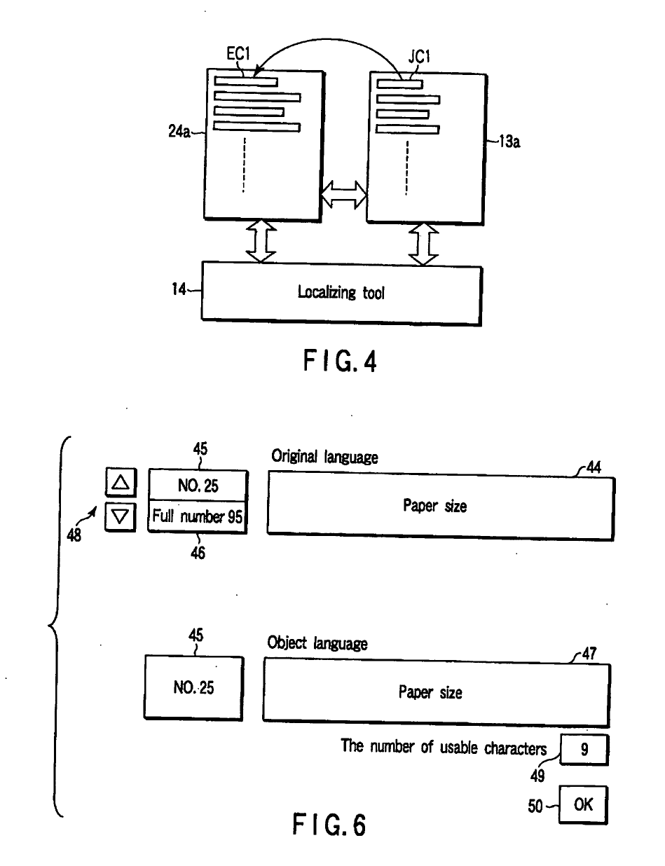

FIG. 4 shows a translation process when English (the document data file 24a) is selected as the original language and Japanese (the document data file 13a) is selected as the object language. For example, the localizing tool 14 erases a character string EC1 in the English document data file 24a and then copies a character string JC1 corresponding to the character string EC1 in the Japanese document data file 13a into the area (the same address area) in which the character string EC1 had been stored. The localizing tool 14 performs such work on all the character strings in the English document data file 24a. Document data files in printer drivers which are in the same language but differ in the number of bits are different from each other in composition. For example, the 16-bit printer driver 11a and the 32-bit printer driver 11b which are both in English are different from each other in the organization of document data files. It is therefore required to prepare two types of document data files for each language: one for 16 bits and one for 32 bits.

In step ST 112, the localizing tool 14 makes a decision of whether all the document files 24 in the printer driver which correspond to the selected OS software forms and original languages have been converted. If there are other document data files 24 to be translated, then the flow returns to step St 109 to translate another document data file 24. In this way, one or more language-converted document data files are created on the memory 32.

Upon completion of language conversion of all the document data files 24 to be translated, the localizing tool 14 erases the original document data file 24 on the HDD which corresponds to the language-converted document data file on the memory 32 and then copies the language-translated document data file into an area where the original document data file had been stored. The localizing tool 14 performs this work for all the language-converted document data files.

Finally, the localizing tool 14 copies the printer driver set 15 created on the HDD into a portable storage medium, such as a CD-R (ST 113). Alternatively, the printer driver set 15 is transmitted over the communication network to another device. As the result, a CD is provided which contains one or more printer drivers into which document data files 13 in object languages have been incorporated.

As described above, this embodiment improves the availability of client software by making easy the language conversion work of translating an original language (for example, English) incorporated into the client software into another language.

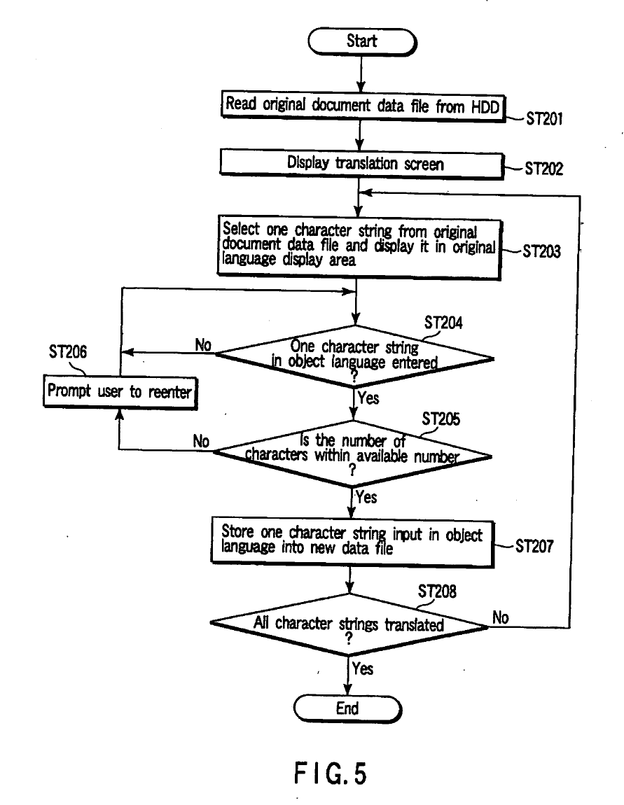

Next, a description is given of an embodiment which adds a new object document data file 13 to a printer driver system. FIG. 5 is a flowchart illustrating an operation of creating a new object document data file 13. Suppose that the printer driver set 15 and the localizing tool 14 as shown in FIG. 1 have been stored in the HDD 26 as in the aforementioned embodiment. In this embodiment as well, the processing is carried out by the localizing tool 14.

First, the localizing tool 14 reads an original document data file 24 in the printer driver 11 from the HDD 36 (step ST 201) and copies it into the memory 32 by way of example. The localizing tool 14 displays such a screen for translation as shown in FIG. 6. Out of two or more character strings stored in the original document data file 24, one is displayed in an original character string display area 44. A character string number 45 indicates the number of character strings stored in sequence into the document data file 24 from becoming disabled from being displayed in the predetermined display area (the ending portion is not displayed) when the language-converted printer driver is executed practically.

Scroll buttons 4B are adapted to scroll the character string number 45, character strings displayed in the original character string display area 44, and character strings entered into the character string input area 47. When one of the scroll buttons 48 is selected, the character string number 45, character strings displayed in the original character string display area 44 and character strings entered into the character string input area 47 are scrolled at the same time.

Returning to the description of FIG. 5, in step ST 203, the localizing tool 14 selects one character string from the original document data file 24 and displays it in the original language display area 44 displayed on the display unit 39.

The localizing tool 14 displays a cursor or the like in the character string input area 47 and waits for a translation of the original character string displayed in the display area 44 to be input (step ST 204). The user selects an “OK” button 50 upon inputting the translation of the original character string. When the translation of the original character string is input (YES in step ST 204), the localizing the first one to the character string displayed in the original character string display area 44. Full number 46 indicates the full number of character strings stored in the original document data file 24.

A character string input area 47 is an area for inputting from the user (translator) a character string translated from the character string displayed in the original character string display area 44 into an object language. Here, there is illustrated an example of translating original character strings into Japanese.

In an available character numbers display area 49 is displayed the number of characters that can be entered into the character string input area 47. The number of available characters varies with the number of characters of a character string being displayed in the original character string display area 44 and is, for example, 1.5 times as many characters as the original character string. In the case of a character string containing kanji characters like the Japanese language, the number of available characters will be fewer than the number of characters in an original character string because kanji characters are larger in width than alphabetic characters.

Thus, by limiting the number of characters that can be entered into the character string input area 47, a translated character string can be prevented from tool 14 makes a decision of whether the number of characters in the input character string is within the number of usable characters displayed in the display area 49 (step ST 205). If the number of characters in the character string exceeds the number of usable characters (NO in step ST 205), then the localizing tool 14 prompts the user to reenter a character string having fewer characters (step ST 206).

When a character string of an appropriate number of characters is input (YES in step ST 205), the localizing tool 14 stores the character string as one character string in the object language into a new document data file 13 in the object language (step ST 207). The localizing tool 14 repeats the above process until character strings in the object language corresponding to all the character strings stored in the original document data file 24 are stored into the new document data file 13 in the object language (step ST 208).

The localizing tool 14 copies the new document data file 13 in the object language thus created into the HDD 36 or a portable storage medium such as a CD-R.

According to the present invention, as described above, language conversion of client software can be made without receiving support from a person who have a full knowledge of the structure of the client software like the designer of a printer driver.

The above description is the embodiments of the present invention, and the apparatus and the method of the present invention are not limited thereto, and various modified examples can be implemented. Such modified examples are included in the present invention. Further, apparatuses or methods which are configured by appropriately combining the components, the functions, the features, or the steps of the method in the respective embodiments are included in the present invention.

What is claimed is:

1. A localizing tool which converts the language of a first document data file, which stores character information of character strings to be displayed in an original language, in a printer driver to another language comprising:
an information storage section;
a printer driver storing section which stores the printer driver in the information storage section; and
a conversion section which converts the first document data file in the printer driver stored in the information storage section into a second document data file in an object language different from the original language.

2. The localizing tool according to claim 1, wherein the printer driver includes a first printer driver having a document data file in a first original language and a second printer driver having a document data file in a second original language, and the localizing tool includes a selecting section which selects one of the first and second printer drivers and a selective conversion section which converts the document data file in the printer driver selected by the selecting section into a data file in the object language.

3. The localizing tool according to claim 1, wherein the printer driver includes a first printer driver of a first form and a second printer driver of a second form which have document data files in the same language, and the localizing tool includes a selecting section which selects one of the first and second printer drivers and a selective conversion section which converts the document data file in the printer driver selected by the selecting section into a data file in the object language.

4. The localizing tool according to claim 1, further comprising
a file storing section which stores a document data file in a first object language and a document data file in a second object language different from the first object language into the information storage section and a selecting section which selects one of the first and second object languages, and wherein the conversion section converts the first document data file in the printer driver stored in the information storage section into a document data file in the object language selected by the selecting section.

5. The localizing tool according to claim 1, further comprising a display unit which displays each of the character strings in the original language contained in the first document data file, an input unit which inputs a plurality of translated character strings obtained by translating the character strings displayed in the display area into character strings in a language different from the original language, and a recording unit which records the translated character strings on a third document data file.

6. The localizing tool according to claim 5, wherein the input unit inputs a character string the number of characters of which is less than or equal to a number based on that of the character string displayed in the display area.

7. A conversion method of converting the language of a first document data file which stores character information of character strings to be displayed and is contained in a printer driver into another language comprising:
storing the printer driver into an information storage unit; and
converting the first document data file in the printer driver stored in the information storage section into a second document data in an original language file in an object language different from the original language.

8. The method according to claim 7, wherein the printer driver includes a first printer driver having a document data file in a first original language and a second printer driver having a document data file in a second original language, and further comprising selecting one of the first and second printer drivers and converting the document data file in the printer driver selected into a data file in the object language.

9. The method according to claim 7, wherein the printer driver includes a first printer driver of a first form and a second printer driver of a second form which have document data files in the same language, and further comprising selecting one of the first and second printer drivers and converting the document data file in the printer driver selected into a data file in the object language.

10. The method according to claim 7, further comprising storing a document data file in a first object language and a document data file in a second object language different from the first object language into the information storage section, and selecting one of the first and second object languages, and wherein the converting converts the first document data file in the printer driver stored in the information storage section into a document data file in the object language selected.

11. An information recording medium stored with a program which converts the language of a first document data file which stores character information of character strings to be displayed in an original language and is contained in a printer driver into another language, the program comprising the steps of:
storing the printer driver into an information storage unit; and
converting the first document data file in the printer driver stored in the information storage section into a second document data file in an object language different from the original language.

12. The information recording medium according to claim 11, wherein the printer driver includes a first printer driver having a document data file in a first original language and a second printer driver having a document data file in a second original language, and the program further comprises the steps of selecting one of the first and second printer drivers and converting the document data file in the printer driver selected into a data file in the object language.

13. The information recording medium according to claim 11, wherein the printer driver includes a first printer driver of a first form and a second printer driver of a second form which have document data files in the same language, and the program further comprises the steps of selecting one of the first and second printer drivers and converting the document data file in the printer driver selected into a data file in the object language.

14. The information recording medium according to claim 11, wherein the program further comprises the steps of storing a document data file in a first object language and a document data file in a second object language different from the first object language into the information storage section, and selecting one of the first and second object languages, and wherein the converting step converts the first document data file in the printer driver stored in the information storage section into a document data file in the object language selected.
